(19) United States
(12) Patent Application Publication
(10) Pub. No.: US 2010/0091229 A1
(43) Pub. Date: Apr. 15, 2010

(54) Compositions and Methods for Alignment Layers

(76) Inventors: Qin Liu, Corvallis, OR (US); Stephen C. Kitson, Bristol (GB); Jeffrey T. Mabeck, Corvallis, OR (US); Charles G. Dupuy, Corvallis, OR (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/251,035

(22) Filed: Oct. 14, 2008

(51) Int. Cl. G02F 1/1337; C09K 19/00

(52) U.S. Cl. 349/123; 428/1.25; 428/1.26

(57) ABSTRACT

Compositions, devices, and methods are provided for a switchable alignment layer coated on a substrate for a liquid crystal device comprising an attachment layer and an adjustable side-chain, where an electric field is capable of changing orientation of the adjustable side-chain between a first state and a second state.

### BACKGROUND OF THE INVENTION

For liquid crystal devices, bistable displays offer the advantages of low cost addressing and potentially low power consumption. In displays using nematic liquid crystals, bistability in the orientation of the liquid crystal (LC) molecules have been obtained by using microstructures, alignment surfaces, or nano-particles. Generally, bistability is a desirable attribute for a liquid crystal display (“LCD”) because this eliminates the need to constantly refresh the display or to employ a silicon memory device behind each pixel, which becomes prohibitively expensive as the number of pixels increases. With bistability, only pixels that are to be changed need addressing, and simple matrix addressing may be employed.

Bistable LCDs include various techniques and known systems including ferroelectric LC modes, nematic LC modes, cholesteric (chiral nematic) LC modes, polymer stabilized cholesteric textures, chiral tilted smectic liquid crystals, phase-separated composite film (PSCOF) technology, SiO coatings, anisotropic gels and polymer coatings. Accordingly, investigations continue into developing LCDs that have improved bistable properties

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1 is a schematic of a method in accordance with an embodiment of the present invention;

FIGS. 2A and 2B are predominantly cross-sectional views of an LCD having a switchable alignment layer in accordance with an embodiment of the present invention; and

FIGS. 3A and 3B are predominantly cross-sectional views of an LCD having two switchable alignment layers in accordance with an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENTS

Before the present invention is disclosed and described, it is to be understood that this invention is not limited to the particular process steps and materials disclosed herein because such process steps and materials may vary somewhat. It is also to be understood that the terminology used herein is used for the purpose of describing particular embodiments only. The terms are not intended to be limiting because the scope of the present invention is intended to be limited only by the appended claims and equivalents thereof.

It must be noted that, as used in this specification and the appended claims, the singular forms “a,” “an,” and “the” include plural referents unless the context clearly dictates otherwise.

As used herein, “attachment layer” refers to a layer that is coated to a substrate or electrode in a liquid crystal device and has an adjustable side-chain, as defined herein, bonded thereto; such bonding can be ionic, covalent, coordinate, or coordinate-covalent. Generally, the attachment layer can be coated and subsequently reacted with a side-chain or can be formed from polymerization of adjustable side-chains with or without other monomers or oligomers. Additionally, the attachment layer can consist of polymers, oxides, or other materials as are known in the art.

As used herein, “adjustable side-chain” refers to a spacer group bonded to a liquid crystal segment, as defined herein, and either bonded to an attachment layer or polymerized to form the attachment layer, as previously described. In other words, the adjustable side-chain is configured to have the spacer group between the attachment layer and the liquid crystal segment. When the adjustable side-chain is polymerized to form the attachment layer, the spacer group and liquid crystal segment extend from the attachment layer as a pendent group. Such polymerization and pendent groups are well-known in the art.

As used herein, “spacer group” generally refers to an organic chain with a functional group on one end and attached to a liquid crystal segment, as defined herein, on the other end. The organic chain can be aliphatic, aromatic, branched or linear, and/or substituted or unsubstituted. As such, the organic chain may contain elements, or heteroatoms, in addition to carbon, e.g., silicon. Generally, the organic chain has one liquid crystal segment attached thereto; however, more than one liquid crystal segment may be attached. For example, a branched organic chain may accommodate more than one liquid crystal segment. Typically, the spacer group contains functional groups that can act as bonding sites for the liquid crystal segment and the attachment layer or for polymerization.

As used herein, “liquid crystal segment” refers to the mesogen part of liquid crystal materials that are bonded to a spacer group, as defined herein. Mesogen is generally defined as the fundamental unit of a liquid crystal that induces structural order in the crystals. Therefore, the liquid crystal segment refers to the part of the liquid crystal that induces structure order in a liquid crystal matrix.

As used herein, “liquid crystal matrix” refers to the liquid crystal material, as defined herein, that is typically found between the substrates of an LCD. Generally, the liquid crystal matrix can be described as vertical or planar when the liquid crystal material contained therein is in a vertical or planar state, as defined herein.

As used herein, “liquid crystal” or “liquid crystal material” refers to a class of materials, including polymers, oligomers, monomers, and molecules, exhibiting a mesophase over a measurable temperature or solvent range, wherein the mesophase lies between the solid or crystalline phase and the liquid phase of the material, and the material exhibits some characteristics of both phases.

As used herein, “planar state” can refer to the orientation of the liquid crystal segment and the liquid crystal matrix. Generally, the orientation in the planar state is when the liquid crystal is oriented predominantly parallel to the substrate surface. As such, a planar state does not depend on gravity or the orientation of an LCD, or other device containing the liquid crystal segment and liquid crystal matrix, with respect to gravity.

As used herein, “vertical state” can refer to the orientation of the liquid crystal segment and the liquid crystal matrix. Generally, the orientation in the vertical state is when the liquid crystal is oriented predominantly perpendicular to the substrate surface. As such, a vertical state does not depend on gravity or the orientation of an LCD, or other device containing the liquid crystal segment and liquid crystal matrix, with respect to gravity.

As used herein, “bistable” or “bistability” refers to a liquid crystal material that is stable in at least two states. As such, bistable LCDs disclosed herein have the ability to remain in at least two different states, including planar and vertical, without voltage being continuously applied. Such bistable LCDs are well-known in the art.

As used herein, “polarizing film” or “polarizing layer” refers to a material that is able to convert an unpolarized or mixed-polarization beam of electromagnetic waves (e.g., light) into a beam with a single polarization state. Typically, LCDs contain two polarized films or layers perpendicular to each other such that light is unable to pass through both films or layers unless a liquid crystal matrix is present between the films or layers and in a planar state. Such a configuration is well-known in the art.

As used herein, “dye-doped” refers to dyes present in a LCD that absorb color when viewed along a defined axis such as a planar alignment. Generally, these dyes can switch orientation with the liquid crystal matrix; i.e., from vertical to planar alignments (or vice versa), which provides a means to control visible portions of the LCD. Such dye materials have orientation dependent absorption of light and are well-known in the art.

As used herein, “microstructure” refers to surface microstructures, and other structures such as posts or holes in a suitable medium, which impart a desired alignment to a liquid crystal material when in contact with the liquid crystal material. Typically, the microstructure will be produced by photolithography, imprinting, or microreplication. However other techniques may also be used to form the microstructure, for example excimer laser ablation through a mask, transfer from a carrier layer, or casting. The microstructure features can typically have a pitch in the range 100 nm to 10 μm, a height or depth in the range 100 nm to 5 μm, width in the range of 100 nm to 5 μm.

As used herein, “lead/follower configuration” refers to one substrate or electrode of an LCD that initiates the alignment of the liquid crystal matrix, also commonly known as a master/slave configuration. Typically, the “lead” or “leader” substrate or electrode initiates the alignment which continues to the other substrate or electrode, the “follower” substrate or electrode. As such, the alignment is driven by the lead substrate or electrode of the LCD. For example, one side of an LCD may have a lead electrode that provides an electric field that causes the liquid crystal segment of an adjustable side-chain to change from a vertical to a planar state, and this change of orientation continues throughout the liquid crystal matrix until at least a portion of the liquid crystal matrix is orientated in a planar state from the lead electrode to the other follower substrate or follower electrode. This term also includes those configurations that result in a less than complete transformation. For example, one side of an LCD may have a lead electrode that provides an electric field that causes the liquid crystal segment of an adjustable side-chain to change from a vertical to a planar state, and this change of orientation continues throughout the liquid crystal matrix until at least a portion of the liquid crystal matrix is orientated in a substantially planar state or less than a substantially planar state at the follower electrode or follower substrate. Generally, the degree to which the LCD achieves or fails to achieve perfectly vertical and planar states can be measured in terms of tilt angle or contrast ratio, as defined herein.

As used herein, “contrast ratio” generally refers to the ratio of the luminance of the bright state to the luminance of the dark state of an LCD. Contrast can also be measured as ΔL*. L* refers to the lightness variable of the CIE L*a*b* system. L* ranges between 0 and 100; L*=0 yields black and L* =100 indicates white. As such, contrast ΔL* measures the difference between the luminance of the bright state and the luminance of the dark state. Such contrast measurements are well-known in the art.

As used herein, “tilt angle” refers to the angle of the liquid crystal matrix from the substrate surface. The tilt angle ranges from 90° in a perfect vertical state to 0° in a perfect planar state.

As used herein, “anisotropy” generally refers to the property of being directionally dependent. In the context of liquid crystals, anisotropy refers to the physical properties of the liquid crystals, such as dielectric constant, refractive index, viscosity, as being dependent upon the direction in which they are measured.

As used herein, “positive dielectric anisotropy” refers to the dielectric constant of the liquid crystal; specifically the dielectric anisotropy is positive when the dielectric constant in the direction approximately parallel to the long molecular axis is larger than that perpendicular to this direction.

As used herein, “negative dielectric anisotropy” refers to the dielectric constant of the liquid crystal; specifically the dielectric anisotropy is negative when the dielectric constant in the direction approximately parallel to the long molecular axis is smaller than that perpendicular to this direction.

As used herein, “substantially” or “substantial” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking, the nearness of completion will be so as to have the same overall result as if absolute and total completion were obtained. The use of “substantially” is equally applicable when used in a negative connotation to refer to the complete or near complete lack of action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still contain such an item as long as there is no measurable effect thereof.

As used herein, “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 wt % to about 5 wt %” should be interpreted to include not only the explicitly recited values of about 1 wt % to about 5 wt %, but also include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

It has been recognized that it would be advantageous to develop liquid crystal devices suitable for development over a wide variety of applications. In accordance with this, compositions, devices, and methods are provided having superior alignment layers for liquid crystal devices. As such, the present disclosure provides switchable alignment layers. When discussing a switchable alignment layer composition, a method having such a composition, or a device containing such a composition, each of these discussions can be considered applicable to each of these embodiments, whether or not they are explicitly discussed in the context of that embodiment. For example, in discussing the attachment layers present in a liquid crystal device, those attachment layers can also be used in a method for making such liquid crystal devices, and vice versa.

A switchable alignment layer coated on a substrate for a liquid crystal device can comprise an attachment layer and an adjustable side-chain. Additionally, an electric field can change the orientation of the adjustable side-chain between a first state and a second state.

In another embodiment, a method of making a switchable alignment layer can comprise coating a substrate with an attachment layer and attaching an adjustable side-chain to the attachment layer, where an electric field is capable of changing orientation of the adjustable side-chain between a first state and a second state.

Alternately, in one embodiment, a method of making a switchable alignment layer can comprise coating a substrate with an adjustable side-chain and polymerizing the adjustable side-chain to form an attachment layer with a spacer group and liquid crystal segment pendent group, where an electric field is capable of changing orientation of the adjustable side-chain between a first state and a second state.

The present disclosure also provides the switchable alignment layers in liquid crystal devices. In one embodiment, a liquid crystal device can comprise an electrode, a switchable alignment layer, as described herein, and a liquid crystal matrix contacting the adjustable side-chain, where an electric field is capable of changing orientation of the adjustable side-chain between a planar state and a vertical state.

In another embodiment, a method of increasing contrast of a liquid crystal device can comprise a) coating a substrate with a switchable alignment layer that comprises i) an attachment layer, and ii) an adjustable side-chain; b) contacting the adjustable side-chain with a liquid crystal matrix; and c) applying an electric field to the adjustable side-chain, such that the electric field changes orientation of the adjustable side-chain and the liquid crystal matrix between a first state and a second state.

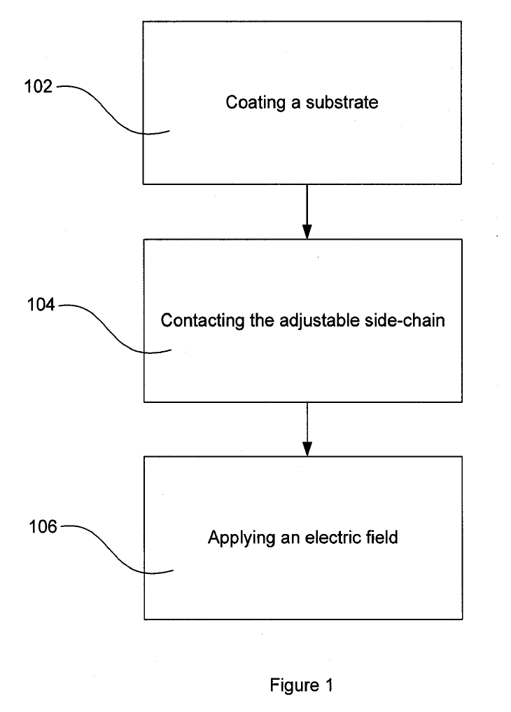

Additionally, a method of increasing contrast of a liquid crystal device is provided. As illustrated in FIG. 1, in one embodiment, the method can comprise coating a substrate at 102 with a switchable alignment layer that comprises an attachment layer and an adjustable side-chain, as previously defined; contacting the adjustable side-chain at 104 with a liquid crystal matrix; and applying an electric field at 106 to the adjustable side-chain; where an electric field changes orientation of the adjustable side-chain and the liquid crystal matrix between a first state and a second state.

The switchable alignment layers described herein can provide improved contrast and bistability. While not intending to be bound by any particular theory, such contrast and bistability can be improved since the switchable alignment layers contain spacer groups that can allow for controlled flexibility in the spatial orientation of the liquid crystal moieties at the alignment surfaces. Such flexible spatial orientation can allow for increased interaction and alignment with the liquid crystal material in the liquid crystal matrix resulting in higher contrast. Additionally, the ability to modify the rigidity of the adjustable side-chain can provide increased and/or decreased anchoring strength resulting in the ability to optimize bistability of individual LCD systems.

When referring to a first and second state throughout the disclosure, the states refer to a difference in spatial orientation of the liquid crystals. Generally, these states can be referred to as planar and vertical, as defined herein. However, such states may also be both vertical or both planar. In one embodiment, the first state can be a planar state and the second state can be a vertical state. The methods and devices described herein can also be capable of multiple states configurations. For example, an LCD may be capable of several intermediate states between planar and vertical. As such, the methods and devices, described herein, may contain a third, fourth, fifth, sixth, etc, states.

In one embodiment, the liquid crystals can allow light to pass through a set of polarized films or layers in one state, while not allowing light to pass through the set of polarized films or layers in the other state. Typically, when the liquid crystal matrix is in the planar state in a LCD, light can pass through a crossed set of polarizing films or layers. The planar state can also include a twisted state that allows light to pass through a crossed set of polarized films or layers, as is known in the art. Typically, when the liquid crystal is in the vertical state in a LCD, light cannot pass through the crossed set of polarizing films or layers. The amount of light that is transmitted may vary as to the individual systems used. In another embodiment, the liquid crystal matrix can by dye-doped. When the dye-doped liquid crystal matrix is in the planar state, the dye molecules can absorb light, while not absorbing light in the vertical state.

The attachment layers described herein can be selected from the group consisting of a polymer, a metal oxide, a semi-oxide, a non-metal oxide, mixtures thereof, and combinations thereof. In one embodiment, the attachment layer can be selected from the group consisting of a polyimide polymer, a polyvinyl polymer, a polyacrylate polymer (including poly(meth)acrylate polymers), a polyether polymer, a polyester polymer, a polyamide polymer, a polysulfone polymer, a polyolefin polymer, a polyphenyl polymer, a polycyclohexane polymer, a polybiphenyl polymer, indium tin oxide, indium oxide, tin oxide, magnesium oxide, silicon oxide, mixtures thereof, derivatives thereof, and combinations thereof.

The substrate can be any substrate as is known in the art. As such, the substrate can contain a material selected from the group consisting of glass, plastic, and metal. In one embodiment, the substrate is a glass substrate. In another embodiment, the substrate is a plastic substrate. In yet another embodiment, the substrate can be a metal substrate. Additionally, the substrate can be an electrode.

The liquid crystal matrix can be selected from the group consisting of phenylcyclohexanes, biphenyls, biphenylcyclohexanes, terphenyls, phenylethers, phenylesters, bicyclohexanes, azomethines, azoxys, pyrimidines, dioxanes, cubanes, monofluoro substituents thereof, difluoro substituents thereof, trifluoro substituents thereof, trifluoromethyl substituents thereof, trifluoromethoxy substituents thereof, difluoromethoxy substituents thereof, polymers thereof, oligomers thereof, derivatives thereof, mixtures thereof, and combinations thereof. In one embodiment, the liquid crystal matrix can include nematic liquid crystals.

Generally, the switchable alignment layers described herein can have an adjustable side-chain. The adjustable side-chain can comprise a spacer group attached to the attachment layer (or polymerized forming the attachment layer) and a liquid crystal segment attached to the spacer group such that the spacer group is orientated between the attachment layer and the liquid crystal segment. As such, the attachment layer can either preexist or be formed by polymerizing the adjustable side-chain.

Generally, the spacer group can have at least two organic functional groups. These functional groups can be the same or different. The organic functional groups can be used for attachment of the spacer group to the attachment layer, attachment of the spacer group to the liquid crystal segment, and/or polymerization of the adjustable side-chain to form the attachment layer. When the adjustable side-chain is polymerized, the spacer group and liquid crystal segment become a pendent group. When the adjustable side-chain is polymerized, the resulting attachment layer can be a homopolymer of the adjustable side-chain or the adjustable side-chain can be polymerized with other monomers (such as methacrylates, acrylates, styrenes, vinyl monomers, etc.) or oligomers containing such monomers. As such, the attachment layer may be a homopolymer, copolymer, terpolymer or multipolymer (a polymer consisting of at least 4 different monomers).

The spacer group can be aliphatic, aromatic, branched or linear, and/or substituted or unsubstituted. The spacer group can be rigid or flexible. In one embodiment, the spacer group can be modified in length and/or rigidity enabling different anchoring strengths of the liquid crystal matrix to the switchable alignment layer.

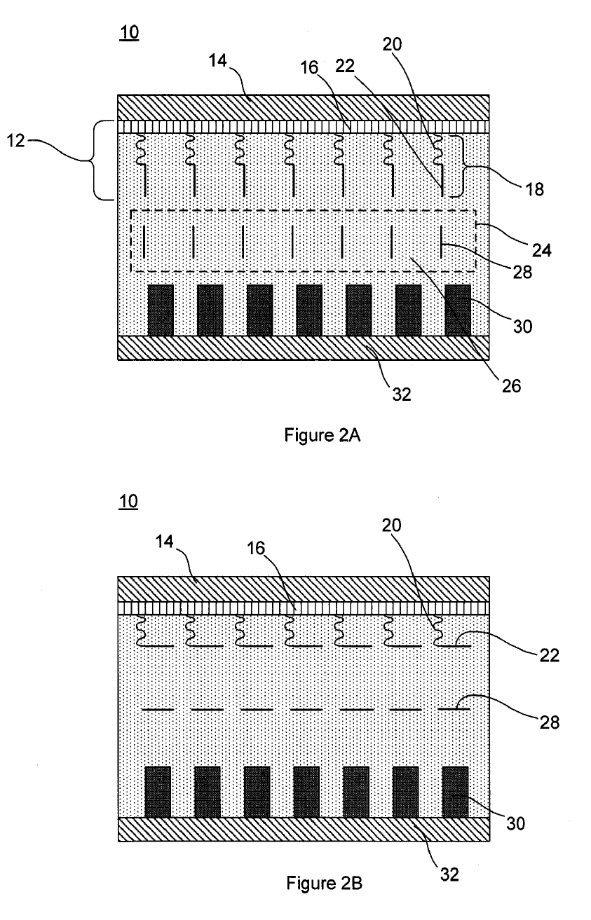

Generally, the LCDs described herein can be bistable devices, however, other LCDs and other optical devices may benefit from the embodiments described herein. In one embodiment, the LCD can be a bistable device. Turning now to FIGS. 2A and 2B, an LCD 10 is shown having a switchable alignment layer 12 attached to a first substrate 14. The switchable alignment layer 12 has an attachment layer 16 with an adjustable side-chain 18 attached. The adjustable side-chain comprises a spacer group 20 attached to a liquid crystal segment 22. The adjustable side-chain contacts the dye-doped liquid crystal matrix 24. The dye-doped liquid crystal matrix 24 comprises dye molecules 26 and a liquid crystal material 28. In addition to the switchable alignment layer 12, the LCD 10 can further include a microstructure 30 attached to a second substrate 32 in a lead/follower configuration with the switchable alignment layer 12. In this embodiment, either the switchable alignment layer 12 or the microstructure 30 can be the lead substrate. In one embodiment, the microstructure 30 can be a Post Aligned Bistable Nematic7 (PABN) post; such as those described in U.S. Pat. No. 6,903,790; which is hereby incorporated in its entirety, or a Zenithal Bistable Display (ZBD) monograting. When the microstructure 30 is the leader, the electric field can change the alignment of the liquid crystal material 28 at the microstructure side of the device, which then propagates through the liquid crystal matrix to the switchable alignment layer 12, the follower. In one embodiment, the switchable alignment layer 12 can change in orientation as shown in FIG. 2B in response to an electric field or other stimulus. As illustrated in FIG. 2A, the liquid crystal segment 22 and liquid crystal material 28 are in a vertical state as compared to the planar state in FIG. 2B.

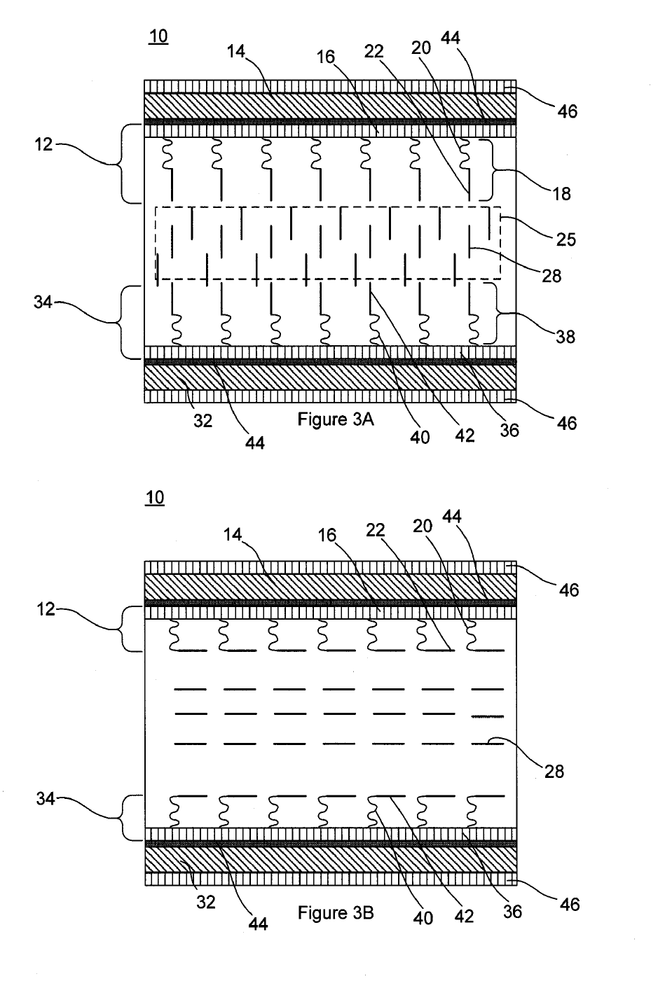

Turning now to FIGS. 3A and 3B, an LCD 10 can further include electrodes 44, polarizing films or layers 46, a second switchable alignment layer 34 attached to an electrode 44, which is attached to a second substrate 32, where the second switchable alignment layer 34 has a second attachment layer 36 coated thereon with a second adjustable side-chain 38 attached. The second adjustable side-chain comprises a second spacer group 40 attached to a second liquid crystal segment 42. The adjustable side-chain contacts the liquid crystal matrix 25. The liquid crystal matrix 25 comprises a liquid crystal material 28. As discussed herein, the first and second spacer groups, the first and second attachment layers, the first and second substrates, and the first and second liquid crystal segments may or may not be the same. Turning to FIG. 3B, the switchable alignment layers, 12 and 34, can change in orientation in response to an electric field or other stimulus, such as heat. The liquid crystal segments 22, 42 and liquid crystal material 28 are in a planar state in FIG. 3B as compared to the vertical state in FIG. 3A.

In one embodiment, the first switchable alignment layer 12 and the second switchable alignment layer 34 can change in orientation in response to different frequencies of electricity. In this embodiment, the LCD can also be in a lead/follower configuration. Additionally, the electric field can be in-plane electric fields or transverse electric fields. The switchable alignment layers described herein can have positive dielectric anisotropies or negative dielectric anisotropies. Additionally, when an LCD has two switchable alignment layers, one can have a positive or negative dielectric anisotropy and the other can have a positive or negative dielectric anisotropy such that the switchable alignment layers have the same or differing dielectric anisotropies.

For illustration purposes, the dye-doped liquid crystal matrix 24 and liquid crystal matrix 25 have been shown as an area between the switchable alignment layer and the microstructure in FIG. 2A and as an area between the switchable alignment layers 18 and 38 in FIG. 3A, respectively; however, the liquid crystal matrix extends to the attachment layers and/or substrate as is well-known in the art.

Additionally, electrodes 44, polarizing films 46, and substrates 14, 32 have been shown in a specific sequence; however, such elements may be configured in alternate configurations. For example, the electrode may serve as the substrate or may be positioned such that the substrate is between the electrode and the attachment layer. Additionally, even though the present figures illustrate a dye-doped liquid crystal matrix in conjunction with a microstructure and a switchable alignment layer (FIGS. 2A,2B), and a non-doped liquid crystal matrix with dual switchable alignment layers (FIGS. 3A,3B), other LCD configurations may also be used with the switchable alignment layers and adjustable side-chains as described herein, including having the dye-doped liquid crystal matrix 24 of FIG. 2A in the LCD 10 of FIG. 3A and having the liquid crystal matrix 25 of FIG. 3A in the LCD 10 of FIG. 2A. One skilled in the art will recognize various modifications and combinations that can be derived from the present disclosure and illustrations. As such, the present depictions should not be considered limiting.

Generally, the LCDs, described herein, have electrodes that produce an electric field that changes orientation of the adjustable side-chain and the liquid crystal matrix from the first or second state to the second or first state. However, other mechanisms for the change in orientation of the adjustable side-chain and/or the liquid crystal matrix are possible. For example, an LCD can further include a thermal property that allows the adjustable side-chain and/or the liquid crystal matrix to change from a first state to a second state and/or reset back to its original first or second state.

As previously discussed, the LCDs can achieve superior contrast characteristics using the switchable alignment layers as described herein. In one embodiment, a dye-doped LCD can have a contrast ΔL* of at least about 30 when the switchable alignment structure is switched between a first state and a second state. In another embodiment, the contrast ΔL* can be at least about 35. In another embodiment, the contrast ΔL* can be at least about 40.

The LCDs described herein can achieve superior tilt angles. In one embodiment, the LCD can have a tilt angle of less than about 20° when the switchable alignment layer is in a first state and a tilt angle of at least about 70° when the switchable alignment layer is in a second state. In another embodiment, the tilt angle can be less than about 10° in a first state and be at least 80° in a second state. In another embodiment, the tilt angle can be less than about 5° in a first state and be at least about 85° in a second state. In another embodiment, the tilt angle can be less than about 20° in a first state and be substantially vertical in a second state. In another embodiment, the tilt angle can be substantially planar in a first state and be at least about 70° in a second state. In another embodiment, the tilt angle can be substantially planar in a first state and be substantially vertical in a second state.

While the invention has been described with reference to certain preferred embodiments, those skilled in the art will appreciate that various modifications, changes, omissions, and substitutions can be made without departing from the spirit of the invention. It is intended, therefore, that the invention be limited only by the scope of the following claims.

1. A switchable alignment layer coated on a substrate for a liquid crystal device, comprising:
a) an attachment layer, and
b) an adjustable side-chain,
wherein an electric field is capable of changing orientation of the adjustable side-chain between a first state and a second state.

2. The switchable alignment layer of claim 1, wherein the adjustable side-chain comprises:
a) a spacer group, and
b) a liquid crystal segment attached to the spacer group such that the spacer group is orientated between the attachment layer and the liquid crystal segment.

3. The switchable alignment layer of claim 2, wherein the spacer group is aliphatic, aromatic, branched or linear, and/or substituted or unsubstituted.

4. The switchable alignment layer of claim 2, wherein the liquid crystal segment is selected from the group consisting of phenylcyclohexanes, biphenyls, biphenylcyclohexanes, terphenyls, phenylethers, phenylesters, bicyclohexanes, azomethines, azoxys, pyrimidines, dioxanes, cubanes, monofluoro substituents thereof, difluoro substituents thereof, trifluoro substituents thereof, trifluoromethyl substituents thereof, trifluoromethoxy substituents thereof, difluoromethoxy substituents thereof, polymers thereof, oligomers thereof, derivatives thereof, mixtures thereof, and combinations thereof.

5. The switchable alignment layer of claim 1, wherein the attachment layer is selected from the group consisting of a polymer, a metal oxide, a semi-metal oxide, a non-metal oxide, mixtures thereof, and combinations thereof.

6. The switchable alignment layer of claim 1, wherein the attachment layer is selected from the group consisting of an polyimide polymer, a polyvinyl polymer, a polyacrylate polymer, a polyether polymer, a polyester polymer, a polyamide polymer, a polysulfone polymer, a polyolefin polymer, a polyphenyl polymer, a polycyclohexane polymer, a polybiphenyl polymer, indium tin oxide, indium oxide, tin oxide, magnesium oxide, silicon oxide, mixtures thereof, derivatives thereof, and combinations thereof.

7. The switchable alignment layer of claim 1, wherein the adjustable side-chain is polymerized to form the attachment layer.

8. A liquid crystal device, comprising
a) an electrode;
b) a switchable alignment layer comprising:
i) an attachment layer,
ii) an adjustable side-chain; and
c) a liquid crystal matrix contacting the adjustable side-chain;
wherein an electric field is capable of changing orientation of the adjustable side-chain and the liquid crystal matrix between a first state and a second state.

9. The device of claim 8, wherein the device is a bistable device.

10. The device of claim 9, wherein the bistable device further includes a microstructure attached to a second substrate in a lead/follower configuration with the switchable alignment layer.

11. The device of claim 8 wherein the device further includes a second switchable alignment layer.

12. The device of claim 11, wherein the switchable alignment layer and the second switchable alignment layer are configured as a lead/follower configuration.

13. The device of claim 11, wherein the switchable alignment layer and second switchable alignment layer have positive dielectric anisotropies, negative dielectric anisotropies, or differing dielectric anisotropies.

14. The device of claim 8, wherein the electrode produces the electric field that changes orientation of the adjustable side-chain and the liquid crystal matrix from the first or second state to the second or first state and the device further includes a thermal property that allows the adjustable side-chain and the liquid crystal matrix to reset back to its original first or second state.

15. The device of claim 8, wherein the device has a tilt angle of less than about 20° when the switchable alignment layer is in the second state and a tilt angle of at least about 70° when the switchable alignment layer is in the first state.

16. A method of increasing contrast of a liquid crystal device, comprising:
a) coating a substrate with a switchable alignment layer that comprises
i) an attachment layer, and
ii) an adjustable side-chain,
b) contacting the adjustable side-chain with a liquid crystal matrix; and
c) applying an electric field to the adjustable side-chain,
wherein an electric field is capable of changing orientation of the adjustable side-chain and the liquid crystal matrix between a first state and a second state.

17. The method of claim 16, wherein coating is achieved by polymerization of the adjustable side-chain on the substrate to form the attachment layer.

18. The method of claim 16, wherein coating is achieved by coating the attachment layer on the substrate and then bonding the adjustable side-chain to the attachment layer.

19. The method of claim 16, wherein the adjustable side-chain comprises:
a) a spacer group, and
b) a liquid crystal segment attached to the spacer group such that the spacer group is orientated between the attachment layer and the liquid crystal segment.

20. The method of claim 16, further including coating a second substrate with a second switchable alignment layer.

21. The method of claim 20, wherein the switchable alignment layer and the second switchable alignment layer forms a bistable device including configuring the bistable device in a lead/follower configuration.

22. The method of claim 16, wherein the contrast of the liquid crystal device is improved by having a tilt angle of less than about 20° when the switchable alignment layer is in the second state and a tilt angle of at least about 70° when the switchable alignment layer is in the first state.

23. A method of making a switchable alignment layer, comprising:
a) coating a substrate with an attachment layer, and
b) attaching an adjustable side-chain to the attachment layer,
wherein an electric field is capable of changing orientation of the adjustable side-chain between a first state and a second state.

24. The method of claim 23, wherein the adjustable side-chain comprises
a) a spacer group attached to the attachment layer, and
b) a liquid crystal segment attached to the spacer group such that the spacer group is orientated between the attachment layer and the liquid crystal segment.

25. A method of making a switchable alignment layer, comprising:
a) coating a substrate with an adjustable side-chain,
b) polymerizing the adjustable side-chain to form an attachment layer with a spacer group and liquid crystal segment pendent group,
wherein an electric field is capable of changing orientation of the adjustable side-chain between a first state and a second state.
